(19) United States
(12) Patent Application Publication
(10) Pub. No.: US 2026/0214512 A1
(43) Pub. Date: Jul. 23, 2026

(54) ON-DEVICE TRAFFIC MONITORING AND APPLICATION-BASED NETWORK SLICING

(71) Applicant: T-Mobile Innovations LLC, Overland Park, KS (US)

(72) Inventor: Do Kyu Lee, Mercer Island, WA (US)

(21) Appl. No.: 19/030,409

(22) Filed: Jan. 17, 2025

(51) Int. Cl. H04W 28/24; H04W 48/16; H04W 48/18

(52) U.S. Cl. CPC H04W 28/24; H04W 48/16; H04W 48/18

(57) ABSTRACT

A method implemented by a collection-report module in a user equipment (UE) improves the quality and efficiency of reporting packet data unit (PDU) session data and updates policies during the PDU session in a network slicing environment. The UE includes the collection-report module and multiple layers. The method collects data vertically across the multiple layers, including status information and metrics related to control plane communications and user plane communications, without changing existing pipeline data flow syntax of the multiple layers; interprets the collected data to ascertain connectivity status and anomalies in the control plane and user plane communications; reports the collected data to the core network; receives a policy update from the core network, including updated policy rules to make the PDU session compliant with a target Quality of Service (QoS); and requests a new PDU session to implement the updated UE route selection policy (URSP).

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The 3rd Generation Partnership Project (3GPP) has defined specifications for network slicing in 5G networks. Network slicing is a technology that makes available a finite arrangement of physical network resources as virtual networks that share the physical resources. Each of these virtual networks defines a “slice” that, when instantiated or “spun up,” can take advantage of the shared physical resources on an as-needed or as-defined basis. Thus, network slicing is based on a physical network infrastructure that supports traffic of different users (subscribers, clients, or the like) sharing the same resources without sharing communications sessions. A user may be, for example, a customer of a telecommunications carrier or a third-party enterprise system (which may also be a customer, or a vendor) that may subscribe to the one or more network slices in the network using user equipment (UE). Therefore, rather than requiring each user to compete for the same resources, network slicing enables the users to in a sense reserve “portions” of each resource that, while still sharing the overall infrastructure, is allocated to an individual user.

### SUMMARY

In at least one embodiment, a UE that may improve the quality and efficiency of reporting PDU session data and updating policies accordingly during the PDU session in a network slicing environment is disclosed. The UE may comprise one or more processors; a communication interface configured to transmit and receive communications between the UE and a core network of a mobile network operator (MNO) and communications over a data network via a user plane controlled from the core network; a layered architecture that includes an application layer having applications, a framework layer having telephony services and a radio interface layer, and a physical layer having a cellular modem, the radio interface layer being an interface between the telephony services and the cellular modem, and the cellular modem being operably connected to the communication interface to transmit and receive information via the communication interface. The UE may further comprise a collection-report module and memory storing the applications to access external data resources from the data network via the telephony services, the radio interface layer, and the cellular modem, the memory further storing computer-executable instructions that are executable by the one or more processors to perform operations comprising: transmitting, via the cellular modem to the core network, a network slice request to access a network infrastructure configured to have multiple network slices over which to communicate with the data network via one or more PDU sessions; receiving, from the core network in response to the network slice request, a slice identifier of a network slice over which the UE is authorized to communicate; executing an application in the application layer to communicate in a PDU session over the network slice; during the PDU session, collecting data to the collection-report module vertically across the application layer, the framework layer, and the physical layer, each layer having a different respective syntax, without changing the syntax of each layer; storing the collected data in a flattened shareable database, each data object in the database having related fields that include an object name, a data identifier, and a timestamp of the data collection; interpreting the stored data to ascertain a status of connectivity and anomalies in the control plane communications and user plane communications; curating the interpreted data for QoS data impacting the QoS on the network slice established through URSP rules instructed by a PCF of the core network functions for use by the UE; transmitting the curated data to a database; receiving, from the core network, a policy update related to the PDU session over the network slice based on the curated data; and adjusting, in response to receiving the policy update, rule-matching logic in the cellular modem to comply with the policy update.

In at least one other embodiment, one or more computer-readable media store computer-executable instructions that, when executed by one or more processors, cause the one or more processors to perform operations that improve the quality and efficiency of reporting PDU session data and updating policies accordingly during the PDU session in a network slicing environment is disclosed. The operations include collecting data vertically across multiple layers in a layered architecture of a UE, the data including status information and metrics related to control plane communications and user plane communications, without changing existing pipeline data flow syntax of the multiple layers; storing the collected status data in a flattened common database, each data object in the database having related fields that include an object name, a data identifier, and a timestamp of the data collection; interpreting the stored data to ascertain a status of connectivity and anomalies in the control plane communications and user plane communications; curating the interpreted data for QoS data impacting the QoS on the network slice established through URSP rules instructed by a policy control function (PCF) of the core network functions for use by the UE; determining whether the curated QoS data indicates a QoS parameter that exceeds a predetermined threshold; determining from the curated QoS data that the QoS for the PDU session fails to meet a QoS target for the PDU session; in response to determining that the PDU session fails to meet the QoS target; sending the curated QoS data to a database; receiving a policy update from the core network that includes an updated URSP to bring the PDU session into compliance with the QoS target; and adjusting rule-matching logic in the UE in accordance with the updated URSP.

In yet other embodiments, a method implemented by a collection-report module installed in a UE to improve the quality and efficiency of reporting packet data unit (PDU) session data and updating policies accordingly during the PDU session in a network slicing environment is disclosed. The UE includes the collection-report module and a layered architecture of multiple layers including an application layer, a framework layer, and a physical layer. The method includes collecting data vertically across the multiple layers, triggered by activity on a network slice, including UE status information and metrics related to control plane communications and user plane communications, without changing existing pipeline data flow syntax of the multiple layers; interpreting the collected data to ascertain status of connectivity and anomalies; reporting the collected data to a database; receiving a policy update from the core network that includes an updated URSP to make the PDU session compliant with a target quality of service (QoS); and requesting a new PDU session over a network slice to implement the updated URSP.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an example 5G architecture that implements network slicing according to at least one embodiment of the disclosure.

FIG. 2 illustrates the concept of network slicing at a very high level, according to various embodiments of the disclosure.

FIG. 3 illustrates a non-roaming service-based architecture (3GPP TS 23.501 v18.6.0 (2024.06)) illustrating separation of the control plane (primarily, the core network) from the user plane, according to at least one embodiment of the disclosure.

FIG. 4 illustrates example components of a UE according to at least one embodiment of the disclosure.

FIG. 5 illustrates functional relationships between a collection-report module and the core network according to at least one embodiment of the disclosure.

FIG. 6 illustrates an example message sequence diagram illustrating an example attachment and PDU session establishment process according to at least one embodiment of the disclosure.

FIG. 7 illustrates an example method that may be performed by a collection-report module in a UE that includes the collection-report module and a layered architecture of multiple layers according to at least one embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

In a mobile network scenario, user equipment (UE), such as a smartphone, accesses resources on a data network such as the Internet. A cellular topology is often used, with the mobile UE able to obtain and maintain access to the data network under management and control by the network operator's core network. In 5G, signaling and management of data sessions on the data network are largely controlled from a control plane (by so-called “control plane functions” (CPFs)) cooperating with hardware and software components of a radio access network in a user plane (implementing “user plane functions” (UPFs)) over which the data traffic flows. A UE is able to obtain access to and communicate over the data network after registering with the network and establishing a data session. In the case of a packet-switched network such as the Internet, a data session is known as a packet data unit session, or PDU session.

Network slicing enables the multiplexing of virtualized and independent logical networks on a physical data network infrastructure. In a sense, network slicing enables usage of hardware and/or software in a virtual network comprising “part” of the physical infrastructure. Accordingly, network slicing allows the network infrastructure to host multiple logical networks that appear and operate as independent networks to a connected user. Some network slices are configured and implemented on a subscription basis; network slicing can also be application-based.

In more detail, network slicing overlays multiple virtual networks on top of a shared network, that is, a set of shared network and computing resources. Each network slice may correspond to a particular logical topology and a separate set of Quality of Service (QoS) policies, security rules, and other parameters, within the limits imposed by the underlying physical networks. Different slices can be dedicated to different applications and use cases, many of which enable, by agreement or functionality, priority access to capacity (bandwidth) or spectrum; guaranteed bit rate, latency, or reliability; and the like for user sessions. Operators can define specific QoS parameters for different services and users, ensuring that applications receive necessary network resources and priority.

Although largely configured, provisioned, and managed by the network operator's core network, a network slice can be requested, and in some cases selected, by the UE. Whether at the UE or core network, network slice selection may be predetermined and configured within a network infrastructure, for example based on policies defining the selection of a network slice for a given application running on the UE. A policy is a framework of rules for controlling network behavior. Rules to enforce a policy (i.e., “policy rules”) may govern, among other things, control of network slicing, session management, access and mobility management, roaming, charging, and QoS for network communications, use cases, network availability, and other considerations.

An appropriate policy supports many use cases, including but not limited to gaming, remote conferencing, V2X, and XR that have different QoS requirements such as bit rate, latency, bandwidth, and others. Network administrators may manually configure the policies for selecting an appropriate network slice for an application based on various factors, such as user profiles, service requirements, or application types. Historically, once configured, the selection remains fixed and static until manual intervention.

Consequently, with dedicated (static) network slicing, if there is traffic congestion, the UE simply suffers as though it were on a legacy network. With network slicing, one can dynamically divide or share existing bandwidth through spectrum allocation and potentially obviate traffic “hogging” by adjusting traffic routing. However, measurement of network performance has been done at the endpoint and is specific to that endpoint. For example, a content server or service provider may measure missing packets at their end. Conditions would then be reported to the core network. Therefore, a response from the core network to improve conditions on the network slice cannot be determined in real time or near real time, but is rather determined later, at the core. If the core had that information earlier, it could respond more quickly to bring QoS back into compliance.

In the course of controlling or managing the PDU session, the core network may monitor traffic in the user plane. From the monitoring, a session management function (SMF) may receive various data (e.g., notifications, statistics, metrics, and the like) for the PDU session. In addition, the core network may receive similar data from the data network to a policy control or policy charging function (PCF). The SMF and/or PCF may analyze this data to detect errors and timeouts, determine whether the PDU session meets QoS requirements, and other things. With this and other information related to the state of the PDU session, the PCF can make adjustments to the policy session for the network slice and reflect the changes as updates to be sent to the UE by the SMF. In some instances, the UE can be assigned a different network slice by the PCF.

Thus, static or dynamic switching can be updated at either the network or UE by rule of routing according to a UE route selection policy (URSP) (which refers to policy information provided to the UE), but control of receiving and routing the data, analyzing the data, adjusting the policy, and reflecting the adjustments to the UE in this way is inefficient. Consider a UE entering a roaming network or transitioning from one cell to another. By a service level agreement (SLA), the user (UE) may be guaranteed a minimum bit rate but find that the actual bit rate does not in fact meet the guarantee. This can be revealed in connectivity data received at the core and analyzing the same, and as a result policies can be updated by the PCF and used by the SMF to control the UPF to adjust traffic routing in the user plane, changing the slice altogether, and reflecting the changes to the UE for it to configure itself accordingly. These cycles are slow, not much different from manual, even if the adjustments are programmable. Furthermore, from the user plane at least, sometimes only authenticated traffic is monitored, and to the extent that the UE controls its participation, switching is limited to resources previously assigned by slice rule.

The present disclosure addresses and improves upon the foregoing and other technical drawbacks by providing a technical solution in the technical field of network slice management, including the UE's individual contribution to network slice management, the core network's individual contribution to network slice management, and the interaction between the UE and core network to improve functionality of both the UE and core network in management of the network slice(s). An advantage and improvement, described herein, configures the UE for monitoring device components for usage of slicing, general authentication issues, and/or quality of datagram packets, and providing feedback to the core network, already in condition to be sent to the PCF without intermediate monitoring or analysis by the SMF or other network functions (NFs) in the core network. In some embodiments, the information is sent “directly” to the PCF from the UE, although it should be understood that the information, following 3GPP standards, may be transmitted to an access and mobility management function (AMF) and then to the PCF, for example, without intervening monitoring or analysis. The PCF may use its own logic to interpret the UE's data, and to determine and make policy changes to make the network slice compliant with the QoS commitment. Accordingly, the slicing policy can be updated in real time at the PCF and updates (e.g., to increase bandwidth, decrease latency, tear down, etc.) reflected “directly” to the UE. The reconfigured slice management improves network slicing to, among other things, meet predetermined and changing requirements for the slice.

To this end, described here is a new way of monitoring traffic in the UE, collecting information (data) across different layers and sub-layers in the protocol stack, and detecting in the information state changes, errors, timeouts, delays, authentication issues, and/or usage metrics (including abnormalities/anomalies) in the network that threaten QoS compliance. The monitored layers may include, for example, a physical layer, a telephony and WiFi framework layer, and an application layer. The information may be collected passively by a collection-report module at the UE, stored in a flattened table on-device, and transmitted to the core network. Additionally, or in the alternative, the collected information may be transmitted to an external database, and stored there in a flattened table for example.

The PCF may generate and record policy updates (e.g., increase bandwidth, decrease latency, tear down, etc.) based on the received data and send the policy updates, or an updated policy, to the UE. For example, the collected data may include or reflect QoS attributes associated with current traffic on the network slice. In some examples, the customer may be subscribed for a low latency, high throughput connection over the network, and a network slice that can meet the required low latency and high throughput may be provisioned for the UE. In this case, the data collected by the collection-report module may indicate values describing the latency and throughput actually implemented along a path of the network slice.

In some embodiments, the data may be curated on the UE (e.g., by the collection-report module) to manage the amount of data to be sent to the PCF. For example, the metrics may be filtered to select the data most relevant to a particular policy or rule and/or by reference to a threshold to limit the amount and type of data (e.g., data from each layer, UE connection timing, and/or the like) to a manageable yet sufficient amount for the purposes of the PCF. The filtered data may then be used (e.g., by the PCF) in updating the policy or policy rules used to select or configure a network slice or UE. In at least one example, the curated data may be stored internally (on-device), associated with a timestamp, the object name, and other related information, in a database. In the database, the data may be stored in a flattened table. In this format, the collection-report module may consume the data internally and determine internally that the threshold has been met, at which time the curated data can be transmitted as it is in its final format. In at least one further example, curation can include applying predetermined criteria related to an expected value range of accumulated data (for example, a range of amount of data), or predetermined measures (amount, type, or the like) related to the identification of potential anomalies, such as data related to software bugs. The curation may remove extraneous data so that what is left is data that it can reliably use to detect anomalies, based on a prior decision of what data to associate with anomalies so as to eliminate data that is not associated with anomalies.

Among other technical advantages and improvements described herein, the UE may provide feedback to the core network on usage of slicing, general authentication issues, and/or quality of datagram packets, already in condition to be sent to the PCF without intermediate monitoring or analysis by the SMF or other network functions (NFs) in the core network. In some embodiments, the information may be sent “directly” to the PCF from the UE as described herein, without intervening monitoring or analysis. In turn, the slicing policy can be updated in real time at the PCF with updates (e.g., to increase bandwidth, decrease latency, tear down, etc.) reflected “directly” to the UE, to meet predetermined and changing requirements for the slice. Thus, from the server side, there is also an advantage in the earlier, on-device curation and/or review of the vertically consolidated data, and in earlier decision-making based on analysis of the collected data. This reduces the time required to correct errors or update policies as needed. Further, because different applications may have different requirements; they can be given different respective slices, with each slice meeting different requirements. Therefore, when updating policies, the PCF can make and provide the needed updates per application, on a slice-by-slice basis, at any time, in real time, on the fly. This also reduces the time spent to correct errors or update policies as needed.

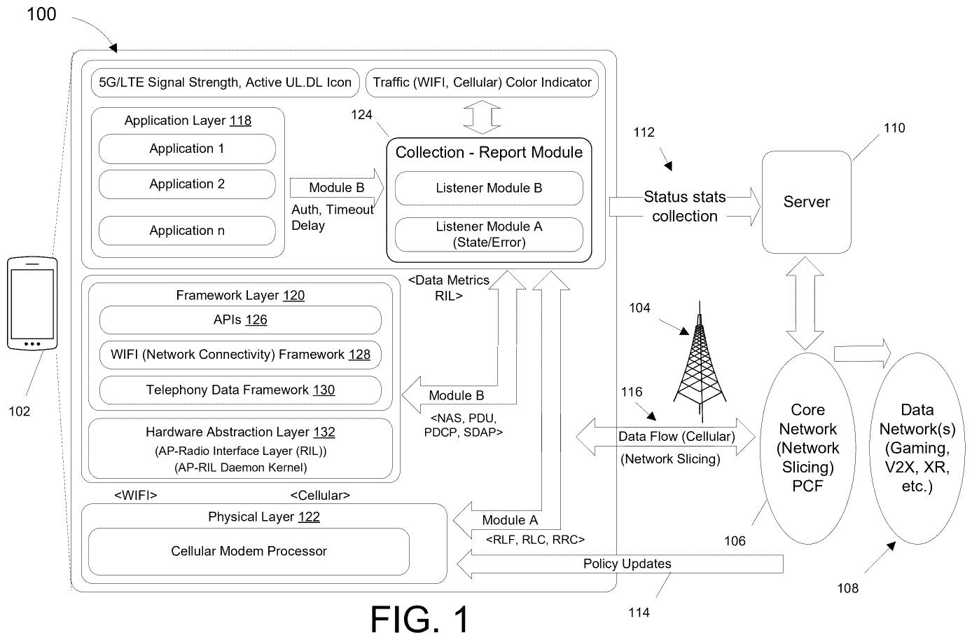

Turning now to FIG. 1, an example 5G architecture that implements network slicing is described according to at least one embodiment of the disclosure. A 5G architecture comprises a control plane and a user plane. The core network is part of the control plane and its network functions (NFs) are control plane functions (CPFs). The core network controls user plane functions (UPFs) to control and manage PDU sessions in the user plane.

The 5G architecture 100 may comprise one or more of a communication device 102 (hereafter, “device” or “UE”), a radio access network (RAN) 104, a core network 106, a data network 108, and a server 110. Registration and PDU session requests from the UE 102 (e.g., from an application running on the UE) to the core network 106 accord with 3GPP standards and are processed by the control plane accordingly. In some embodiments, status statistics (“stats”) 112 collected within the UE 102 may be transmitted by the UE 102 to the server 110. Policy updates 114 may be determined in the core network 106 by a PCF and transmitted to the UE 102. Data flow 116 (such as data traffic in a cellular network) between the UE 102 and the data network 108 are via the user plane as managed by the control plane in accordance with 3GPP standards.

The UE 102 may be a cell phone, a mobile phone, a smartphone, a personal digital assistant (PDA), an Internet of things (IoT) device, a wearable device, an XR device, a headset device, a laptop computer, a tablet computer, a notebook computer, a medical device, a vehicle computer, or like device that has network slice capability. The UE 102 may be owned and operated by a customer or subscriber of the network operator. In some embodiments, the UE 102 may have an application layer 118 comprising multiple applications 1-n, a framework layer 120, a physical layer 122, and a collection-report module 124. The application layer 118 may include, by way of example and not limitation, one or more applications for accessing static or streaming content from remote content sources, participating in virtual meetings, and/or accessing other computing resources via a data network such as the data network 108 shown in FIG. 1.

The UE 102 may be configured to communicate over the carrier network via one or more network slices. In this disclosure, examples are given of UE communication over one network slice, but no limitation should be inferred as the disclosure enables one of ordinary skill to practice the technology with communication over multiple slices, consistent with the concepts and examples given. The application layer 118, framework layer 120, and physical layer 122 are abstractions as is known in the art and are described in more detail elsewhere herein. It should be noted that, in different contexts, their physical components may be described differently by those of ordinary skill in the art without loss of understanding or clarity.

The application layer 118 may comprise multiple applications, including applications that provide utility and/or productivity functionalities to a user of the UE 102. The applications may include, without limitation, telephony applications, electronic mail applications, remote desktop applications, web browser applications, navigation applications, multimedia streaming applications, gaming applications, and/or conferencing applications, to name but some examples. In some embodiments, the applications may include one or more consumer applications, which may be pre-loaded or later installed. Some applications may require support for eMBB (enhanced Mobile Broadband), URLLC (Ultra-Reliable Low Latency Communication), MIoT (Massive IoT), V2X (Vehicle-to-Everything), and HMTC (High-Performance Machine-Type Communication).

The collection-report module 124 may be a software process under middleware to an operating system, executable by one or more processors to passively monitor, on device, components of the UE 102, including but not limited to those abstracted as layers (e.g., the application layer 118, framework layer 120, and physical layer 122) in the present disclosure. In some embodiments, the collection-report module 124 may comprise, without limitation as to number, a listener module A and a listener module B. The listener module A may monitor the physical layer 122 for state, errors, and/or the like, whereas the listener module B may monitor the application layer 118 for anomalies such as authentication failures, timeouts, and/or delays, and the framework layer 120 for anomalies in a NAS communication or PDU session, and/or in packets transiting a PDCP sub-layer or an SDAP sub-layer. The listener module B may further monitor the physical layer 122 for anomalies in a radio link sub-layer (for radio link failures RLF), radio link control (RLC) sub-layer, and/or a radio resource control (RRC) sub-layer. In other embodiments, the collection-report module 124 may be a single module that monitors the multiple layers. In this way, the collection-report module 124 is able to provide insight into the status of the network slice assigned to an application that is currently using the slice, without waiting for detection or confirmation from the network side. In some examples, the collection-report module 124 may be implemented on an integrated circuit chip.

The framework layer 120 may comprise application programming interfaces (APIs) 126, a WiFi framework 128, a telephony data framework 130, and a hardware abstraction layer 132 having a radio interface layer (RIL) with RIL Daemon kernel. The framework layer 120 may comprise software executable by one or more processors for carrying out at least telephony functions such as, without limitation, making and ending calls; mediating application requests to the RIL; and exposing APIs to the application layer for access to the modem for text, data transmission, audio and/or video calls (including SIM, VoIP, VoNR, VoLTE, and/or the like, depending on device configuration), etc.

The physical layer 122 may include cellular modem hardware and software to send and receive data in the data flow 116 in accordance with any of a variety of protocols. For example, communications across a packet data network such as the Internet may implement TCP/IP. In the present context, the data flow 116 is confined to a network slice established for the PDU session or sessions.

The RAN 104 may include a base station located at or near a tower such as a cell tower. The RAN 104 is responsible for handling voice and data traffic between multiple user devices (such as the UE 102) and the data network 108, and signaling and data transmissions between the control plane and the user plane via the N1 and N2 interfaces, including information collected by the collection-report module 124 and sent to the core network 106. In the illustrated embodiment of FIG. 1, the RAN 104 is in the form of a gNodeB (gNB). The RAN 104 may communicate via an antenna system over an air interface with one or more UEs that are within range. The antenna system may include multiple antennas that are mounted on a radio tower to provide a coverage area that is referred to as a “cell” or “sector.” The RAN 104 may comprise radios, baseband units, and other components to send and receive wireless communications to and from the UE 102 via an air interface, to send and receive wired and/or wireless communications via a backhaul to and from the core network 106, and to transmit and receive data to and from the data network 108 over the user plane. The RAN 104 thus provides the UE 102 a wireless (from the standpoint of the UE) communication link to the core network 106, supporting varying network slicing capacities tailored to different generations of wireless telecommunication protocols and use cases. Some or all of the base stations and/or other components of the RAN 104 may be owned and/or operated by the network operator or licensor/licensee.

The core network 106 may anchor a telecommunication carrier network that belongs to or is controlled by an MNO or virtual MNO. In this regard, some or all components of the RAN 104, in some cases even including the tower, may be considered components of both the RAN 104 and the carrier network, for convenience. Some or all of the core network 106 may be owned and/or operated by the network operator.

The core network 106 carries out various network functions, including but not limited to UE registration for access to the data network 108, PDU session establishment and management, QoS enforcement, traffic filtering based on predefined policies, network slicing, policy enforcement, mobility management, and other control plane functions. The core network 106 may store subscriber data related to the end user operating the UE 102, and also may store customer or vendor data related to one or more third-party enterprise systems that subscribe to use or are permitted to use the functions in the core network 106 and the radio elements in the RAN 104 to deliver content or services to the UE 102. Elements of the core network 106 may be implemented using virtual computing devices in the form of virtual machines or software containers that are hosted in a computing cloud. The computing cloud may include a variety of disaggregated servers that provide virtual application server functionalities and virtual storage functionalities. The core network 106 may be configured to implement a 5G standalone (SA) or non-standalone (NSA) wireless telecommunication protocol.

The data network 108 may include one or more private networks, one or more public networks, or a combination thereof. Examples of the data network 108 may include public networks such as the Internet and private networks such as access-restricted local area networks or wide area networks. The data network 108 has a data network name (DNN) that identifies the data network.

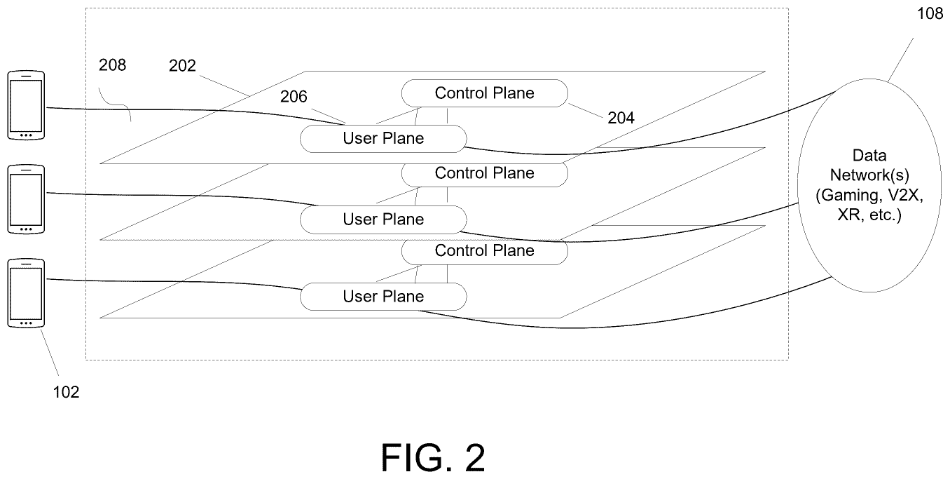

FIG. 2 illustrates the concept of network slicing at a very high level, according to various embodiments of the disclosure. A slice 202 may comprise a control plane 204 and a user plane 206 for each PDU session 208. The control plane 204 handles signaling and control functions in setting up and managing the PDU sessions. The user plane 206, on the other hand, is responsible for the transmission of user data from the UE 102 over the data network 108. While they may be similarly configured within the overall network infrastructure (e.g., share infrastructure that supports their respective control plane functions), each slice 202 may have different configurations to support their respective requirements. For example, one slice 202 may be configured to support very high availability, very low latency (e.g., V2X, remote surgery), high availability, low latency (e.g., enterprise IoT), wide area coverage, Internet access (eMBB), and low cost, low energy (MIMO IoT).

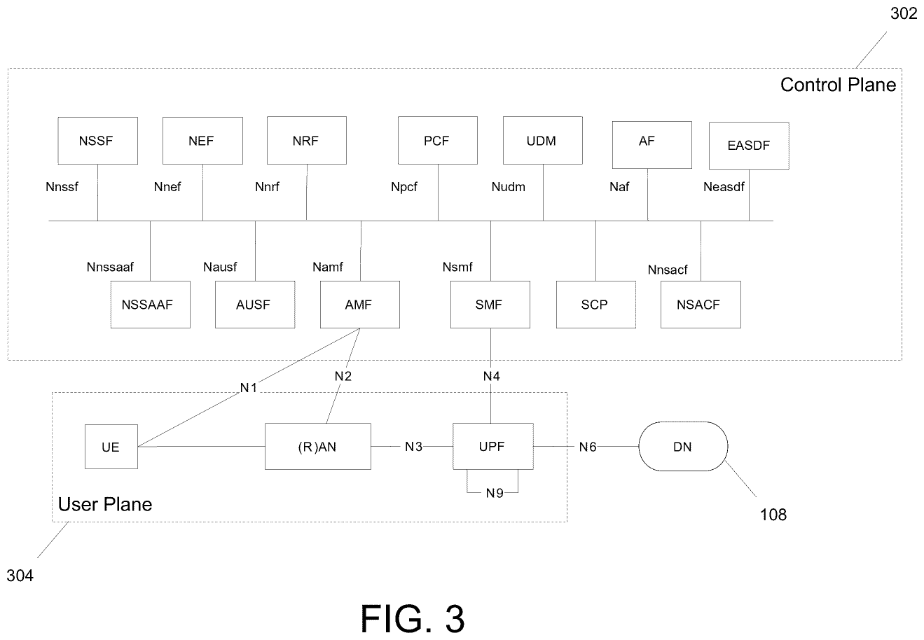

FIG. 3 illustrates a non-roaming service-based architecture (3GPP TS 23.501 v18.6.0 (2024.06)) illustrating separation of the control plane 302 (primarily, the core network) from the user plane 304, according to at least one embodiment of the disclosure. The core network comprises various network functions (NFs) to perform or facilitate operations that may include, without limitation, UE registration and authentication, PDU session establishment (including network slice creation and/or selection) and management, policy session creation, policy rule generation and updating, network exposure, and others.

As illustrated, in the control plane, the core network may comprise such NFs as an access and mobility management function (AMF), which facilitates many functions such as UE registration and authentication; a network slice selection function (NSSF), which provides network slice information to the AMF and facilitates the management and orchestration of network slices across the network; a network exposure function (NEF), which makes available NFs to external networks; a network repository function (NRF), which is a registration hub for other control plane functions; a policy control or policy charging function (PCF), which provides and updates network and network slice policies, as well as charging policies relative to the subscriber and its usage of the network; a unified data management (UDM) function, which maintains the universal data repository (UDR) and stores/retrieves information in the UDR for other NFs; an application function (AF), which exposes the application layer for interaction with the NFs and external network resources and supplies information to the PCF to identify traffic for policy and charging control; an edge application server discovery function (EASDF), which enables a domain name server to determine the closest available edge server; a network slice-specific authentication and authorization function (NSSAAF), which creates a slice authentication context for the UE and starts a slice-specific authentication and authorization procedure; an authentication server function (AUSF), which authenticates the UE to the core network in response to a communication from the AMF; a session management function (SMF), which controls/orchestrates the NFs, including managing PDU sessions and, with the PCF, enforcing QoS and other policies; a service communication proxy (SCP), which facilitates NF intercommunication; and a network slice admission control function (NSACF), which monitors and controls the number of registered UEs and established PDU sessions per network slice.

In some implementations, the core network may maintain in the UDR a collection of S-NSSAIs known as an NSSAI. Each S-NSSAI may be characterized by a slice selection type (SST), and optionally a slice differentiator (SD). Whereas an SST defines a slice by its features and functions, an SD indicates a specific slice, useful for example when there are more than one slice supported in the same SST. An SD also may be used to divide UEs into groups that call for slices having the same features and functions. Examples of SSTs may include, without limitation, eMBB (enhanced Mobile Broadband), URLLC (Ultra-Reliable Low Latency Communication), MIoT (Massive IoT), V2X (Vehicle-to-Everything), and Hmtc (High-Performance Machine-Type Communication).

The illustrated user plane 304 may comprise such components as the UE, the RAN, and the UPF. Dashed lines are used to indicate functionality rather than relative hardware or software locating, and different persons of ordinary skill in the art, while recognizing the control plane—user plane separation (CUPS), may consider the composition of the control plane and/or user plane differently without confusion or meaningful inconsistency, and without departing from the spirit and scope of the teachings herein.

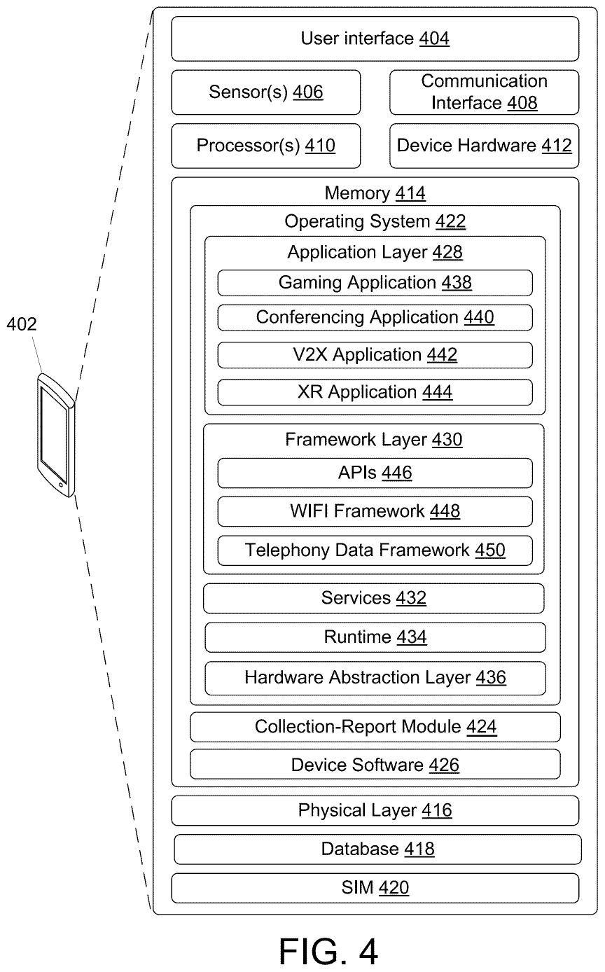

FIG. 4 illustrates example components of a UE 402 according to at least one embodiment of the disclosure. The UE 402 may correspond to the UE 102 and include a user interface 404, one or more sensors 406, a communication interface 408, one or more processors 410, device hardware 412, memory 414, a physical layer 416, a database 418, and/or a subscriber identity module (SIM) 420.

The user interface 404 may enable a user to provide input and receive output from the UE 402, including for example providing one or more input to initiate device activation. The user interface 404 may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

The sensor(s) 406 may include a proximity sensor, a compass, an accelerometer, an altimeter, and/or a global positioning system (GPS) sensor. The proximity sensor may detect movement of objects that are proximate the UE 402. The compass, the accelerometer, and the GPS sensor may detect orientation, movement, and geolocation of the UE 402.

The communication interface 408 may include wireless and/or wired communication components that enable the UE 402 to transmit or receive voice or data communication via the RAN 104, as well as other telecommunication and/or data communication networks.

The processor(s) 410 may be operably connected to the memory 414. In at least one example, the processor(s) 410 may include central processing unit(s) (CPU), graphics processing unit(s) (GPU), or both CPU(s) and GPU(s) and/or any suitable sort of processing unit(s). Each of the processor(s) 410 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution. The processor(s) 410 may also be responsible for executing any or all computer applications stored in the memory 414.

The device hardware 412 may, for example, include signal converters, transceivers, antennas, hardware decoders and encoders, graphic processors, a SIM card slot, and/or the like that enable the UE 402 to execute applications and provide telecommunication and data communication functions.

The memory 414 may be implemented using computer-readable media, such as computer storage media. Computer-readable media include, at least, two types of computer-readable media, namely computer storage media and communications media. Computer storage media include volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital optical disks or other optical storage, magnetic cassettes, magnetic tape, magnetic disk storage or other magnetic storage devices, or any other non-transmission medium that can be used to store information for access by a computing device. In contrast, communications media may embody computer-readable instructions, data structures, program modules, or other data in a modulated data signal, such as a carrier wave, or other transmission mechanism. As defined herein, computer storage media do not consist of and are not formed exclusively by modulated data signals, such as a carrier wave.

The memory 414 may store an operating system 422, a collection-report module 424, and/or device software 426. The various applications and other software described herein may include routines, program instructions, objects, and/or data structures that perform particular tasks or implement particular abstract data types.

The operating system 422 may include an application layer 428, a framework layer 430, services 432, a runtime environment 434 for executing applications in the application layer 428, and/or a hardware abstraction layer 436. The operating system 422 may process data using the processor(s) 410 to generate output based on input received via the user interface 404. The operating system 422 may further include a presentation component that presents the output (e.g., displays the data on an electronic display, stores the data in memory, transmits the data to another electronic device, etc.). An example operating system 422 that may be suitable for one or more of the embodiments described herein is Android OS, a mobile operating system based on the Linux kernel.

The application layer 428 or the framework layer 430 can broadcast to the collection-report module 424 via an API 446. For example, part of a logical API 446 in the framework OS can deliver data objects to the collection-report module 424. In the alternative, or in addition, it can write the objects in a common shared database, such as the database 418 or an external database (for concision, “the database 418” may refer to either an internal (on device) database or an external database, unless context dictates otherwise). In some embodiments, data may be sorted, filtered, and/or synced before being stored or updated in the database 418, associated with a timestamp, the object name, and other related information in a table. When the database 418 is on device, this novel arrangement enables the UE 402 to consume (e.g., curate, compare to thresholds, and/or determine when to send to the core network) the data internally, from any or all layers.

The applications in the application layer 428 may include any over-the-top (OTT) application that can use a network slice. The applications may comprise instructions stored in the memory 414 on the UE 402, which when executed by one or more of the processor(s) 410 of the UE, cause them to perform functions described herein as well as other functions. The applications may include one or more consumer applications, examples of which may include a gaming application 438 for accessing static or streaming content or services from remote content sources, a conferencing application 440 for participating in virtual meetings, a V2X (Vehicle-to-Everything) application 442 for communications between a vehicle and an entity or entities (such as infrastructure (V2I), a network (V2N), other vehicle (V2V), etc.), and/or an XR (eXtended Reality) application 444 for participating in activities that overlay a virtual environment over a physical environment, via a data network such as the data network 108 shown in FIG. 1.

The framework layer 430 may correspond to the framework layer 120 of FIG. 1 and comprise one or more application programming interfaces (APIs) 446, a WIFI framework 448, and a telephony data framework 450. The APIs 446 may represent software interfaces that, among other things, permit the applications in the application layer 428 to communicate with other applications internal or external to the UE 402. For example, one or more of the APIs 446 may be used to deliver network information related to connectivity, latency, QoS, throughput, and the like to the core network 106.

The Wi-Fi framework 448 is an abstraction layer that may comprise software executable by the processor(s) 410 for carrying out at least typical WIFI functions such as, without limitation, searching for available networks; establishing a connection, directly or via a router, access point, or both, to a device or network; managing and participating in communications over the established connection via APIs, and the like.

The telephony data framework 450 is an abstraction layer that may comprise software executable by the processor(s) 410 for carrying out at least typical telephony functions such as, without limitation, making and ending calls, mediating application requests to the RIL, and providing APIs to access the UE 402 for text, data transmission, audio and/or video calls (including SIM, VoIP, VoNR, VoLTE, and/or the like, depending on device configuration), etc.

The services 432 may include application components that run in the background without user participation. Foreground services can operate when the application is closed. Background services are stopped when the application is stopped. Bound services provide an interface through which a bound application allows the components of the application, for example, to send requests, receive responses, and perform interprocess communications (IPC). Bound services perform their tasks in the background as long as any application component is bound to it.

The hardware abstraction layer 436 offers an interface to implement functionality, allowing communications between the OS stack and hardware components (including the device hardware 412 and the cellular modem) without affecting or modifying code in higher level systems. The hardware abstraction layer 436 may include, for example and without limitation, the RIL. The RIL (which may correspond to the RIL in FIG. 1 but is not shown in FIG. 4 for clarity) may provide, via the RIL daemon kernel, the boot-up environment, as well as the protocol stack for data transfer between the applications and the physical layer 416. According to at least one embodiment, the RIL may provide an interface, associated with wireless communication, between an application and the cellular modem in the physical layer 416. For example, applications included in the application layer 428 may control the cellular modem through the RIL using one of the APIs 446 provided from the telephony data framework 450 and may transmit and receive messages with the cellular modem.

The collection-report module 424 may correspond to the collection-report module 124 of FIG. 1. In some embodiments, the collection-report module 424 may be configured as software executable to passively monitor and collect, on device, data from the application layer 428, the framework layer 430, the hardware abstraction layer 436, and/or the physical layer 416, and share the data between the different layers as well. The collection-report module 424 also may be configured to collect data from other layers, additionally or alternatively. In addition, or alternatively, the collection-report module 424 may be configured with software to perform analysis of the collected information.

In the data collected from the monitoring, the collection-report module 424, via its collection-report modules (e.g., corresponding to the listener modules A and B shown in FIG. 1 but omitted here for clarity) can detect indicators of network conditions and anomalies in any or all layers. For example, the collection-report module 424 may collect data from the physical layer 416, the application layer 428, and the framework layer 430 as stated, but also from the MAC layer, RLC layer, packet data convergence protocol (PDCP) sub-layer (which is responsible for compression, encryption, and integrity protection of user data in the user plane and of signaling data in the control plane), service data adaptation protocol (SDAP) sub-layer (which maps QoS flows from the applications to radio bearers to ensure QoS and prioritization in the user plane), RRC layer (control plane), and NAS layer (control plane). By way of illustration, in the lower layers (e.g., the physical layer 416 and framework layer 430), usage data and datagram packet quality (sufficiency or insufficiency) in the network slice traffic can be collected, and in the upper layers (especially the application layer 428), errors in authentication to the network, response delays, timeouts, etc. can be detected.

Statistical data (“metrics”) and status data (“status” or “state”) gathered or derived from the monitoring can be sent to the core network (e.g., AMF or PCF). Each layer's information contained in the status data and metrics may be encapsulated by the collection-report module 424 per the protocol of its standard and recovered by “disassembling” the data flow into each different layer.

Additionally, or in the alternative, the metrics and status data can be transmitted to an external database and stored so as to be retrievable by elements of the core network, including without limitation the SMF and PCF. In either case, the data as it leaves the UE 402 may be already curated for the PCF and thus can be consumed by the PCF as received without further filtering, processing, or the like. In this way, the collection-report module 424 is able to provide insight into the status of the network slice assigned to an application that is currently using the slice, and insight into the functioning of the device itself.

Absent the collection-report module 424 collecting information from the layers vertically, each layer typically would send data individually to the core network. This means that the core network must collect the data, analyze it for errors and status (including traffic-related issues), and make decisions about what and how to implement remedies. Making decisions as the data comes in may result in decisions and remedies being based on incomplete data, and making decisions after a certain amount or type of data comes in may result in remediation delays. Having the collection-report module 424 on device, statistical and status data can be gathered earlier and consolidated earlier. In addition, absent on-device listening and with each layer communicating individually with the server, a dropped error message from one layer might never reach the server for processing with data from the other layers. Thus, from the server side, there is an advantage in the earlier, on-device curation and/or review of the vertically consolidated data, and in earlier decision-making based on analysis of the collected data. This reduces the time required to correct errors or update policies as needed.

An illustrative example can be a video call suffering from poor video resolution. In this nonlimiting example, the collection-report module may detect in packets transiting the lower layer (e.g., physical layer 416) an indicator of poor resolution, which impacts QoS. Data collected from an upper layer (e.g., application layer 428) may show packet loss. In some embodiments, the raw data may have been sent directly to the collection-report module 424; in other embodiments, the raw data can be stored in the database 418 (e.g., in a flattened table) for retrieval by the collection-report module 424. In either case, the collection-report module 424 may periodically (e.g., every 85 seconds) sample and measure aspects of the data.

Once the classifications, fields, etc. of the database 418 are defined, the basis for reporting can be determined. For example, one group can be a group of data, such as bootup data or data of transitioning from one cell to another. Data of that group may be collected only once to several times per day. Another group may provide data more frequently, on the order of seconds, and a third much more frequently, for example callbacks, on the order of milliseconds. Each layer collects different data at different times, in different amounts, at different frequencies, etc. for storing in corresponding fields (e.g., timestamp, amount, frequency, etc.). Data can be entered in different tables, related tables, or a single table, for example. In some embodiments, the database 418 or collection-report module 424 may perform a learning regression on data being curated and compare the output with a predetermined threshold or a predetermined trend.

The device software 426 may include software components that enable the UE 402 to perform various functions. For example, the device software 426 may include a basic input/output system (BIOS), Boot ROM, or bootloader that boots up the UE 402 and executes the operating system 422 following power-up of the UE 402.

The physical layer 416 may correspond to the physical layer 116 of FIG. 1 and include a cellular modem processor and a front-end module (FEM) to send and receive information (e.g., signals, commands, and data) via an antenna (e.g., of the device hardware 412) in accordance with any of a variety of protocols. For example, communications across a packet data network such as the Internet may implement TCP/IP.

The database 418 may be utilized in some embodiments for receiving and storing raw data from the various layers. The database 418 may be omitted in some embodiments, such as embodiments in which the collection-report module 424 receives, stores, and performs analysis on the raw data before reporting the raw data and analysis (if any) to the core network 106.

The database 418 can be a shared database into which raw data collected by the collection-report module 424 from more than one application in the application layer 428 can be entered. For example, an application may have access to contact information in an address book. Another application, such as a dialer, may have its own database with contact information. The shared database can be constructed to hold all of the contact information in common for sharing by the applications. If defined properly, the database 418 can also store raw data collected by the collection-report module from the framework layer 430 and the physical layer 416 as well, and store the data from each layer in its own syntax as received. That may be frequently, such as every millisecond, or less (even much less) frequently. The frequency of reporting the data to the core network (described elsewhere herein) can reflect the frequency of collection, or it can depend on the amount of data or another factor or factors. In some embodiments, a similarly functioning database can be external to the UE 402, for example on an enterprise server that can be accessed by NFs in the core network or other nodes to store, update, and/or retrieve needful data.

The SIM 420 may be an integrated circuit chip that is inserted into a SIM card slot of the user device 402, or an embedded SIM that is hardwired onto a universal integrated circuit card (UICC). During attachment, as described elsewhere herein, when the user activates the SIM 420 on the UE 402, the core network 106 can determine from the SIM whether the UE 402 supports network slicing, what characteristics of a slice it supports, and the policy or policies governing configuration of a slice for that user, such as a charging policy and requirements based on use case and/or subscription terms (e.g., high bandwidth, spectrum, or low latency).

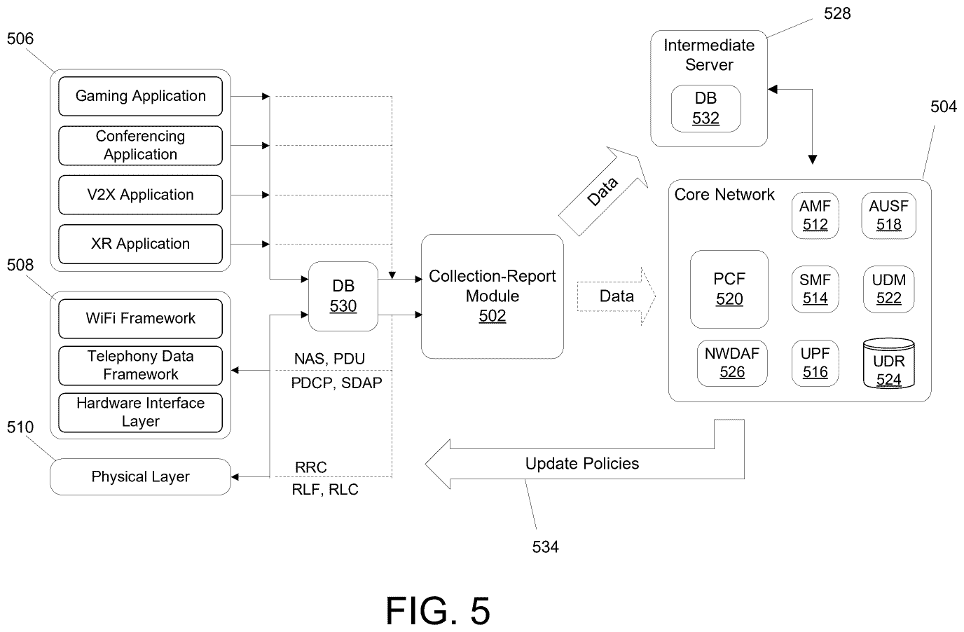

FIG. 5 illustrates functional relationships between the collection-report module and the core network according to at least one embodiment of the disclosure. As shown in FIG. 5, a collection-report module 502, which may correspond to the collection-report module 424, may transmit information gathered from an application layer 506, a framework layer 508, and a physical layer 510 to a core network 504. The application layer 506, the framework layer 508, and the physical layer 510 may correspond to the application layer 428, the framework layer 430, and the physical layer 416, respectively. The core network 504 may correspond to the core network 106. The collection-report module 502 resides in a UE (e.g., UE 402) and may communicate with the core network 504 via a RAN (not shown) in the user plane. In some embodiments, the core network 504 may comprise network functions (NFs) that include one or more of an AMF 512, SMF 514, UPF 516, AUSF 518, PCF 520, UDM 522, UDR 524, and NWDAF 526.

The collection-report module 502 may collect data including data bearer information, status, and/or metrics related to, e.g., authentication, network connectivity, QoS, error detection, and the like, vertically across the application, framework, and physical layers 506, 508, and 510, respectively; consolidate the data; and transmit the data for consumption at the core network 504.

The information gathered by the collection-report module 502 may be curated (e.g., interpreted, analyzed for various purposes, and/or filtered) to remove data that does not meet a predetermined usage threshold. Absent a threshold, the sheer amount of data collected by the collection-report module 502 could delay analysis and transmission to the core, and it is unnecessary to process all of the collected data to provide enough information to be usable and useful for consumption by the PCF 520. Some or all of the curating can be performed on the device, per a schedule, periodically, aperiodically, or in response to a trigger, even though each layer's data is independent of the others'and has a different syntax.

In some embodiments, the UE 402 may send the raw data via the physical layer 510 to the NWDAF 526 and/or UDM 522 via the SMF 514. In turn, the PCF 520 may retrieve the raw data from the UDM 522. The data can then be stored in a database such as a database 530, which may correspond to the database 418. Additionally, or alternatively, the data may be transmitted to an intermediate server 528 for storage in an external database 532. In some embodiments, data objects in the database retain the existing pipeline flow syntax of each of the monitored UE layers in the database fields. The packets still have authentication and still have the DNN, through the baseline of the flow. This obviates parsing at the end node of the network; the data can be processed for various purposes within the device. In some embodiments, listening and transmitting collected data of the multiple layers may be performed during registration, described below.

In some embodiments, status data related to the application layer 506 may include responses from the core network 504 to requests for authentication or authorization of an application to the network, errors, delays, or timeout responses. In such embodiments the collection-report module 502 may detect in the status data indication of a failure in access to a network resource by one of the applications due to a failure to authenticate the application to the core network 504, a timeout, or a delay, and a policy update 534 described below is a response to change the network slice to resolve the access failure. In some embodiments, the status data may include QoS metrics in a PDU session that indicate a drop in QoS below a QoS target for the PDU session, and the policy update response is to change the PDU session to a network slice that meets the QoS target for the PDU session.

Statistics provided from an external network, for example a content delivery network (CDN), are known to reflect authentication of a UE or conditions at the CDN server, but not to measure the quality of the statistics or prediction capability of the UE. The collection-report module 502 is able to collect similar information from multiple on-device layers, make these determinations, and send them, with or without the raw data to the core network (or intermediate database) and/or, in some cases, present data or convey information to the user (i.e., “device not authenticated” via the user interface), or present data to an application for consumption there for purposes related to the data, such as a timeout or retry for example.

The AMF 512 may be responsible for many functions such as connection and mobility management, including authentication. With the UDM 522 and AUSF 518, the AMF 512 may facilitate UE registration and authentication to the network, and also handle network slice requests, for the UE 402. In addition, the AMF 512 may transmit session management messages between the UE 402 and the SMF 514.

The SMF 514 may collect information related to packet session management from other core network functions, and control/orchestrate these network functions based on, for example, a request from the AMF 512. For example, the SMF 514 may manage PDU sessions of the UE 402. Throughout the PDU session, the SMF 514 may maintain the session context, which contains necessary information about the PDU session, such as the allocated resources, policy rules, and other session parameters.

In some embodiments, the SMF 514 may receive a PDU session establishment request from the AMF 512 and, in response, obtain policies (rules) from the PCF 520 to configure the PDU session, including QoS rules established for the user and use case, and pass the policies to the UE 402. The SMF 514 may also select the network slice or instantiate one based on UE request, requirements, and/or an SLA, and control the UPF 516 to ensure correct routing of packets in conformity with the QoS policy.

The UPF 516, with the SMF 514, may facilitate communications between the UE 402 and the data network. For example, the SMF 514 may communicate a traffic steering configuration to the UPF 516 for proper traffic routing. This may be based at least in part on QoS parameters and other session management parameters sent by the SMF 514 to the UPF 516 to implement a slice selected or configured by the SMF 514, and to control the slice during the PDU session. To this end, the UPF 516, among other functions, may enforce policy rules on the user plane so that data packets are handled according to the policies defined by the PCF 520.

The AUSF 518 may authenticate and/or authorize the UE 402 to the network, and vice versa, in response to a communication from the AMF 512. For authentication, the AUSF 518 may check user credentials provided in the registration request against user profiles stored in the UDR 524. For authorization, the AUSF 518 may obtain user subscription information stored in the UDR 524, e.g., in a user profile, via request to the UDM 522, and validate subscription information for the user, including but not limited to access privileges and requirements for QoS, charging, and security. The AUSF 518 may send the result of authentication and authorization (yea or nay) to the AMF 512.

The PCF 520 may govern network behavior via defined policy rules, enforced on the user plane in cooperation with various control plane and user plane functions. The PCF 520 may store policies for PDU session management in the UDR 524, for example, with one or more policy identifiers and an association of both to the UE 402 or subscriber to which the policies apply, and provide them or associated policy identifiers to the SMF 514 in response to a request from the SMF. In some embodiments, the PCF 520 may provide the SMF 514 with policies that influence resource access, provision, prioritization, and management, carried out by the UPF 516 as instructed by the SMF 514, along with QoS and other requirements for meeting SLAs and user needs, for example. Policy rules may be applied to specific data flows. In one or more embodiments, the PCF 520 may also perform various charging functions, including but not limited to tracking network usage (e.g., data, time, and resources), ensuring accurate billing for subscribers, and event reporting for billing purposes.

The PCF 520 may provide the policies or policy identifiers to the AMF 512 to support its functions. In addition, the PCF 520 may generate and record in the UDR 524 any policy updates (e.g., increase bandwidth, decrease latency, tear down PDU session, etc.) based, for example, on the current status of network connectivity, satisfaction of QoS parameters, charging, and/or changes in a user SLA.

The PCF 520 may further provide policy information to the UE 402. The policy information can be used by the UE 402 to determine whether an application can use an established PDU session, or to trigger the establishment of a new PDU session. The policy information provided to the UE 402 typically includes a UE route selection policy (URSP). The URSP defines rules (“URSP rules”, “policy rules”, or simply “policies”) for the UE 402 to configure itself to match uplink data traffic to parameters for an established or to-be-established PDU session over an assigned network slice, and/or to select a route for data traffic based on, e.g., network type, QoS requirements, congestion, etc. URSP rules may include, among others, a network slice selection policy (NSSP) by which the UE associates an application with an S-NSSAI. URSP rules can govern access control, charging (e.g., based on data usage and/or service), and QoS, among other things. Some rules may be dynamic rules that can be modified based on network conditions and policy updates. Other rules may be preconfigured and static, i.e., rules that do not change dynamically.

The URSP may be pre-configured in the UE 402 or may be provisioned to the UE from the PCF 520. In some embodiments, URSP rules may be updated by the PCF 520 if the monitored data indicates a loss or potential loss in QoS over the current network slice. In general, the PCF 520 may select the URSP based on the subscribed S-NSSAIs and other policies such as policies that concern current slice usage and load, for example to ensure that the network slice maintains a guaranteed bit rate for the UE 402 (or for another UE). In some embodiments, the PCF 520 may provide the URSP to the AMF 512, which then sends the URSP to the UE 402. Additionally, or in the alternative, an established user preference, stored in the UDR 524 and retrievable by the PCF 520 or SMF 514, may take precedence over a slice selection policy in the URSP.

In some embodiments, to manage QoS for a particular PDU session, the PCF 520 may match service levels with traffic patterns and consumer profiles, incorporate them into policy rules, and supply the policy rules to the SMF 514. A similar process may be carried out when the policy rules are updated by the PCF 520 sending an updated URSP to the UE 402. In some embodiments, the policy update sent to the UE 402 may include a URSP to make a non-compliant PDU session compliant with a QoS commitment. In some embodiments, the URSP makes the PDU session QoS compliant by defining parameters for the UE 402 to implement by changing its rule-matching logic to change the QoS flow to one that is QoS compliant. In some embodiments, the URSP may make the PDU session QoS compliant by defining parameters for the UE 402 to implement by changing its rule-matching logic to implement a new PDU session to a different network slice.

With these rules, the SMF 514 can set and maintain resource allocations to enforce the policies for a given network slice. Real-time needs created by changes in current network conditions, usage, subscription, and the like can be communicated by the SMF 514 to the PCF 520 to respond dynamically by updating policies to ensure that QoS requirements continue to be met, even per application or slice. In some embodiments, data reported by the collection-report module 502 may be provided to the NWDAF 526 and/or the UDM 522 for retrieval by the PCF 520, or the PCF 520 can retrieve data reported by the collection-report module 502 to an intermediate server 528. Such data can be in a form that the PCF 520 can readily interpret and use to generate updates to the policy for the network slice and incorporate them in the URSP sent to the UE 402.

Notably, the UE 402 does not have to request a modification to the URSP because, through receiving the collected data “directly” from the UE, the PCF 520 can make its own policy update decisions based on the received data. Further, because different applications may have different requirements; they can be given different respective slices, with each slice meeting different requirements. Therefore, when updating policies, the PCF 520 can make and provide the needed updates per application, on a slice-by-slice basis. All policy changes do not need to be applied across the board, so routing, for example, can be adjusted for just a single slice, at any time, in real time, on the fly. These are further advantages, and improvements, over arrangements in which the PCF gathers its data only from external sources on the respective reporting schedules of the external sources.

The UDM 522 may be considered the front end for the UDR 524 and make subscription-related data stored there available to various NFs. For example, the UDM 522 may provide the AMF 512 with subscriber-related data stored in the UDR 524, including subscription and authentication information utilized by the AMF 512 when registering the UE 402; provide subscriber data to the SMF 514; generate and provide UE authentication parameters to the AUSF 518; and exchange analytics data with the NWDAF 526. In at least some embodiments, the PCF 520 will not obtain policy-related context from the UDM 522; instead, the PCF will communicate directly with the UDR 524 for data stored there.

The UDR 524 is or may include a database that may store one or more of subscription data, user profiles, user authentication information, encryption keys, policies, and other user-and subscription-related information. Various NFs can store, retrieve, update, and delete information from the UDR 524. For example, the PCF 520 may communicate directly with the UDR 524 to store, retrieve, update, and delete policies and policy-related data and updates. Further, application data can be stored in the UDR 524 by external AFs via the NEF.

The NWDAF 526 is a type of diagnostics to detect the quality of data traffic in an additional query for the quality for the service itself. It is a methodology standard that may be applied to determine the quality reflected in the raw data collected by the collection-report module 502. To this end, the NWDAF 526 may provide network data analytics (i.e. load level information) to the PCF 520. In some embodiments, the PCF 520 may collect slice-specific network status analytics from the NWDAF 526. In general, to support the collection of data, an AF may receive data reports from UEs and various systems, networks, and servers external to the core network via PDU sessions, and expose events to the NWDAF 526. The NWDAF 526 can analyze the data and provide analytics to core network functions, including the PCF 520. To this end, the NWDAF 526 may perform certain analysis (e.g., calculating KPIs) on the collected data that helps them to manage network performance, predict traffic, and improve security, for example. Among data that can be provided by the NWDAF 526 to the PCF 520 are load level data and network congestion data, which the PCF may use in its policy decisions related to traffic steering and/or resource allocation, periodically or aperiodically. In some embodiments, the PCF 520 may be connected directly to the NWDAF 526.

The intermediate server 528 may be configured at least in part with similar components to a typical server, and further to include the database 532 configured to be or have a table (e.g., a flattened table) to receive and store data collected by the collection-report module 502 in a similar fashion to the database 418. Thus, while the database 532 may be set up externally to the UE 402, the advantages that flow from the collection-report module 502 by virtue of its being on device, and collecting, curating, and storing status and metrics on-device, remain.

The database 530 may be utilized in some embodiments for receiving and storing raw data from the various layers. The database 530 can be a shared database into which data collected from the application layer 506, the framework layer 508, and the physical layer 510 may be stored in its own syntax as it is received, and reported at a frequency suited to the frequency of its collection as described elsewhere herein.

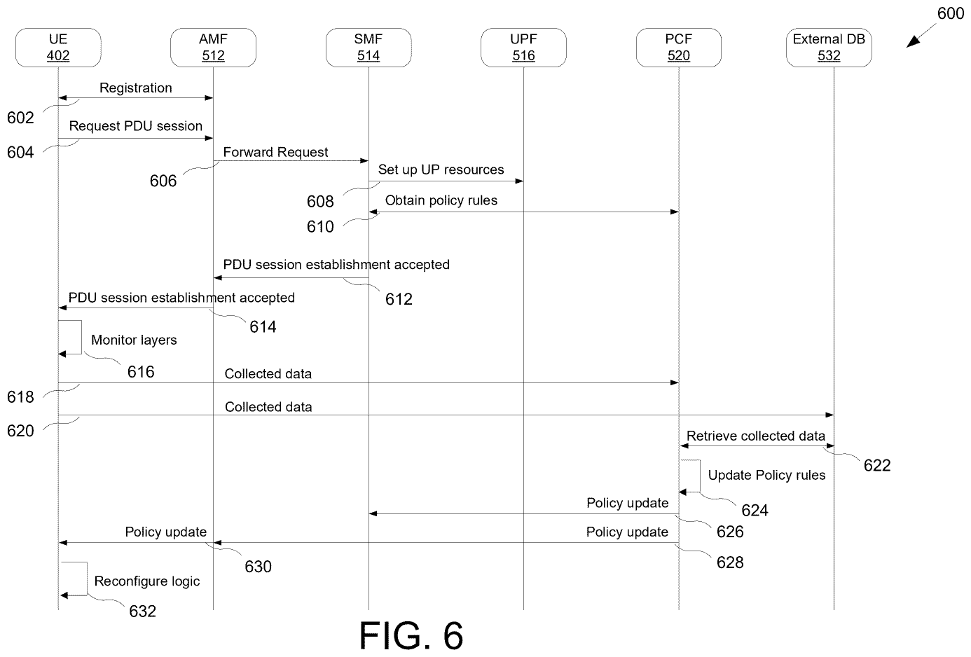

FIG. 6 illustrates an example message sequence diagram 600 illustrating an example attachment and PDU session establishment process according to at least one embodiment of the disclosure. In some embodiments, the process may be implemented by various components in the architecture 100 of FIG. 1 with reference to FIG. 5. For illustration purposes, only the UE 402, AMF 512, SMF 514, UPF 516, PCF 520, and external database 532 are shown. Furthermore, only some components and steps in the process 600 are shown and described. It should be noted that one of ordinary skill in the art may define attachment and/or PDU session establishment to omit some of these steps, add other steps, and/or constitute combinations of these.

To initiate attachment, at 602, the UE 402 may send to the AMF 512, using the N1 interface, a request to register with the network. The request may be sent in response to a trigger, for example by a user initiating UE bootup and activating the SIM 420. To participate in a PDU session, the registered UE 402 must be configured to comply with policies that govern communication over the network slice. For example, the UE 402 may be configured with route information and a table (e.g., 5QI table) mapping QoS flows to QoS characteristics. When the user activates the SIM 420 on the UE 402, the network server (used interchangeably herein with core network, core, or network as context allows) can determine from the SIM 420 whether the UE 402 is thus configured to support network slicing, what characteristics of a slice it supports, and the policy or policies governing configuration of a slice for that user, such as a charging policy and requirements based on use case and/or subscription terms such as high bandwidth, spectrum, or low latency. In some examples, the network server may give the UE 402 a default routing policy for its slice and, as the UE is moving, the network server, with the gNB, can reconfigure routing connections to use the established slice. Thus, the UE 402, UPF 516, and some network functions may need to be updated and the related decisions can be made at the network.

The registration request message may include, without limitation, a UE identifier and an NSSAI, which is a list of S-NSSAIs that the UE 402 is capable of using and which comply with requirements of the UE. For example, the registration request message may include a requested network slice configured with network resources that support QoS parameters (e.g., a guaranteed latency, bit rate, etc.) for a particular use case, which may be defined in an SLA. By way of nonlimiting example, the network slice may be configured to support a bandwidth of 600 MHz, 2.5 GHz, and/or mmWave with latency of 10 ms, 5 ms, and/or less than 10 ms. These parameters can be encapsulated in the request by the UE 402 for the network slice, for example by identifying or defining a particular SST. Alternatively, or in addition, the SST can be defined on the network side (i.e., by the network server).

The AMF 512 may receive the registration request message and, in response, initiate an authentication check of the requested S-NSSAI(s) against the NSSAI maintained for the UE 402 (subscriber) in the UDR 524. For example, the AMF 512 may request the AUSF 518 to authenticate the UE 402 based on subscriber information contained in the registration request and/or subscriber information stored in the UDR 524 that can be obtained from the UDM 522, which may include the subscriber's allowed NSSAI, and comparing its allowed S-NSSAI(s) to the requested slice. Once authenticated, the AMF 512 sends a Registration Accept message to the UE 402 with the allowed network slice or slice list, along with other information for the UE 402 to configure itself for data communication on an allowed network slice. The AMF 512 may also send a UE Policy Create Request to the PCF 520, which may respond with the set of policy rules based on policy logic designed to comply with QoS requirements for the slice, among other things.

During attachment, when the user activates the SIM 420 on the UE 402, the network server can determine from the SIM whether the UE supports network slicing, what characteristics of a slice it supports, and the policy or policies governing configuration of a slice for that user, such as a charging policy and requirements based on use case and/or subscription terms such as bandwidth, spectrum, and/or latency. The UE 402 is configured with policy rules that allow it to select an S-NSSAI based on the application it wishes to use (depending on, e.g., QoS requirements of the application). So for example, if the UE 402 has two PDU sessions, where one is established via a first S-NSSAI for a URLLC slice towards the data network 108 identified by its DNN, while the other is established via a second S-NSSAI for an eMBB slice towards the same DNN, when the UE 402 needs to send traffic for a first application over the first slice (corresponding to the first S-NSSAI), the UE finds a matching traffic descriptor in the policy rule and selects the first PDU session according to the corresponding route selection descriptor. The same holds for a second application communicating over the second slice (corresponding to the second S-NSSAI) and the second PDU session.

The UE 402 may request a particular S-NSSAI. The S-NSSAI may be requested in three cases in general: 1) when the SIM 420 is inserted and read from the UE 402 for the registration, 2) when a designated application service is launched from the upper layer via user input, and 3) if the UE 402 has a mobility issue and a change in network slice is needed, which can be detected at the core network (policy changes may be needed for any particular S-NSSAI changes).

In some embodiments, the NSSP may determine the S-NSSAI to which the PDU session is to be assigned. Thus, for example, when a gaming application such as the gaming application 438 requests a network slice, the UE 402 may receive from the AMF 512 the URSP rules obtained from the PCF 520, determine the traffic type from a traffic descriptor, ascertain the properties that the gaming application requires, and route its traffic to a PDU session having the route selection descriptor. That is, the UE 402 may associate the gaming application to the PDU session that matches the route selection criteria. More than one PDU session may match, in which case the UE 402 may select one (or more, as the application may communicate over more than one PDU session (although only one application may be assigned to a PDU session)).

The request may specify parameters (e.g., 5QI, bit rate, latency, maximum packet loss rate, security specifications, and the like) for the slice and, in response, the SMF 514 will attempt to select a slice or slices that meet the requested parameters and that are allowed by the network operator. The request from the UE 402 may be based on a customer subscription plan (e.g., SLA) guaranteeing a certain minimum bit rate or other QoS attribute(s) for the UE, for example. In some embodiments, the S-NSSAI may have a predefined set of parameters assigned for the UE 402 or use case. S-NSSAIs allowed by the network operator for the user/UE may be stored, e.g., in the UDR 524. The UDM 522 may access the UDR 524 to obtain and provide the AMF 512 with one or more S-NSSAIs and in turn send them to the UE 402, where they can be stored in the SIM 422. With this information, the UE 402 can select an S-NSSAI having the necessary parameters and configure its uplink and downlink to connect to a PDU session over the network slice (a default S-NSSAI may also be provided; the ultimate slice selection rests with the network). The DNN for the data network 108 also can be included in the network slice request, although it may not necessarily correspond to a particular slice of the data network 108. Correspondingly, the S-NSSAI can be stored in the UDR 524 by the UDM 522 with a reference to the UE 402. Thereafter, the AMF 512 can retrieve this information the next time the UE 402 requests registration and a network slice, without involving the SMF 514.

Following successful registration, a PDU session can be established. In some embodiments, an application in the application layer 428 of the UE 402 may initiate the process. To establish a PDU session, at 604, the UE 402 may send a PDU session establishment request message to the AMF 512. The request may contain information such as a desired SST, DNN, SSC mode, and other relevant parameters.

At 606, the AMF 512 may forward the request to the SMF 514. Correspondingly, at 608 the SMF 514 may set up user plane resources with the UPF 516. For example, the SMF 514 may reconfigure the RRC for the registered UE 402 based on the UE's capabilities and send the reconfigured RRC to the gNB. The gNB may then send an RRCReconfiguration message to the UE 402 that includes additional configuration information, such as the radio bearer and physical layer configurations.

At 610, the SMF 514 may obtain from the PCF 520 a URSP, which is a collection of policy rules that enforce a corresponding NSSP. The NSSP is used by the UE 402 to associate a matching application with an S-NSSAI to which the PDU session is assigned. One or more rules in the URSP may correspond to the same NSSP. The request from the UE 402 may be based on a customer subscription plan guaranteeing a certain maximum bit rate or other QoS attribute(s) for the UE, for example.

The URSP dictates parameters of the PDU session, (e.g., QoS, charging, etc.), and in particular the PDU session over the assigned network slice. In some embodiments, the SMF 514 may create a policy session during which it obtains the URSP from the PCF 520 and transmits the URSP to the UPF 516 to set up the necessary user plane resources.

In some examples, the network slice may be instantiated or assigned to the UE 402 in accordance with the URSP. Each slice has a URSP defined for that slice and more than one application can use the same slice/have the same URSP (in different PDU sessions). The URSP tells the UE 402 what slice to use if there is one available that the UE may use and that meets the requirements for QoS, etc. If there are more than one slice that meet the requirements, the UE 402 can pick one according to its own logic. If the UE 402 tries to acquire a slice that is not available, it will get an error message.

Thus, for example, when a gaming application requests a network slice, the UE 402 may receive the URSP rules, determine the traffic type from a traffic descriptor (e.g., application number), ascertain the properties that the gaming application requires, and routes its traffic to a PDU session having the route selection descriptor. If needed, the traffic can be moved to a non-3GPP session outside the PDU session, or can trigger establishment of a new PDU session. That is, the UE 402 may associate the gaming application to the PDU session that matches the route selection criteria. This may be performed, for example, by logic in the physical layer 510. More than one PDU session may match, in which case the UE 402 selects one (or more, as the application may communicate over more than one PDU session (although only one application may be assigned to that PDU session)). If no PDU session matches the route selection criteria, then the UE requests a new one by proceeding to the next rule. If the UE 402 tries to acquire a slice that is not available; it will get an error message.

Once the necessary resources are allocated and policy rules are set, at 612, the SMF 514 may inform the AMF 512, which in turn may send a PDU session establishment accept message to the UE 402 with PDU session configuration information, such as the QoS parameters, the IP address, and other configuration information as is typically used. At 612, the SMF 514 may send a message to the AMF 512 that the PDU session establishment is accepted and, at 614, a corresponding message is sent from the AMF 512 to the UE 402. With the PDU session established, the UE can now transfer data over the network slice. Throughout the PDU session, the SMF 514 may maintain the session context, which contains all the necessary information about the PDU session, such as the allocated resources, policy rules, and other parameters.

At 616, the collection-report module 502 may monitor the various layers and collect status data vertically across the multiple layers, including status information that may indicate errors, timeouts, delays, etc., and metrics that may indicate anomalies in data traffic. The data collected by the collection-report module 502 may include data collected during establishment of the policy session. In addition, or in the alternative, the collected data may include status data collected during establishment of the PDU session. The collection-report module 502 may listen across all slices for each layer's status and metrics, in each layer's syntax, and store the data with an association to each corresponding slice.

In some embodiments, the collection-report module 502 may monitor the layers and collect data anytime during the establishment of the policy session as well.

In some embodiments, the multiple layers may comprise the application layer 506 having multiple applications, the framework layer 508 having telephony services and a RIL, and/or the physical layer 510. In some embodiments, the collection-report module 502 may determine the amount of collected data and the amount of collected data by type of data; store the amount of collected data in the database 530 and/or database 532 associated by type; and compare the amount of at least one of the types of data with a respective threshold.

In some embodiments, the collection-report module 502 may monitor packets in each of the multiple layers independently of each other layer. Anomalies in the monitored packets may include anomalies in one or more of timeouts, authentication failures, or delays. Moreover, anomalies in data traffic of the PDU session may be detected in the data gathered from the PDCP sub-layer and/or an SDAP sub-layer from among the monitored packets collected from the framework layer 508, and anomalies in one or more of a radio link sub-layer, RLC sub-layer, and RRC sub-layer may be detected from among the monitored packets collected from the physical layer. The collection-report module 502 may listen across all slices for each protocol layer's metric, in each protocol layer's syntax, and store the collected data with an association to each corresponding slice.

At 618, the collection-report module 502 may report the collected data to the core network (e.g., to the PCF 520 via the NWDAF 526 and/or UDM 522). Alternatively, or in addition, the data can be reported to the external database 532 at 620. In some embodiments, the collected data may be sent in response to the amount of data of one of the types of data exceeding its respective threshold. Some of the metrics may indicate a need for remediation at the moment analyzed if not collected, substantially in real time. Some of the data can wait in a queue but, for example, data sampled and analyzed with high frequency may hit their threshold quite quickly and can be delivered then. A shareable database can facilitate quick collection, curation, analysis, and delivery/retrieval for action by the PCF 520.

At 622, assuming collected data was sent to the external database 532, the PCF 520 may retrieve the collected data on a schedule or in response to a triggering event. In some embodiments, other NFs in the core network can do the same.

At 624, the PCF 520 may update policy rules for the UE 402 and/or network slice being used by the UE 402. For example, the anomalies in the collected data may include anomalies detected from among the monitored packets collected from the application layer 506, the framework layer 508, and the physical layer 510. Examples of anomalies may include a failure in access to a network resource by one of the applications due to a failure to authenticate the application to the core network, a timeout, or a delay, and the policy update is a response to change the network slice to resolve the access failure. In such embodiments the collection-report module 502 may detect in the collected data indication of a failure in access to a network resource by one of the applications due to a failure to authenticate the application to the core network, a timeout, or a delay, and the policy update may be generated as a response to change the network slice to resolve the access failure.

In some embodiments, a new QoS may be dictated by a new situation, such as a new use case (e.g., initiating a gaming session during a voice call), change in the current use case (e.g., dropping video from a video conference), or change in network conditions (e.g., load balancing to alleviate traffic congestion) that requires or enables a new network slice that meets the new situation.

For example, the PCF 520 may analyze the data and determine, based on anomalies or other information indicating that QoS is non-compliant or may become non-compliant, the need for changes to the URSP. Accordingly, the PCF 520 may generate policy updates (e.g., increase bandwidth, decrease latency, tear down, etc.) based on the collected data and send the policy updates, or an updated URSP, to the UE 402 and SMF 514. For example, the collected data may include QoS attributes associated with providing the network slice. In some examples, the customer may be subscribed for a low latency, high throughput connection over the network, and a network slice that can meet the required low latency and high throughput may be provisioned for the UE 402. In this case, the parameters collected by the collection-report module 502 may indicate values describing the latency and throughput actually implemented along a path of the network slice. At times, the QoS attributes may not meet the needs for a particular use case or agreement and reflected in the policies for the active network slice. The PCF 520 may make this determination by comparing the QoS attributes to the policy and, as a result, may determine that a new network slice is warranted and send a URSP with the necessary changes to the UE 402. In some embodiments, the PCF 520 may adjust the network slice (routing, for example) and send that information to the UPF 516 and gNB as well.

The PCF 520 may also provide the policies or policy identifiers to the AMF 512 to support its functions. In addition, the PCF 520 may generate and record in the UDR 524 any policy updates (e.g., increase bandwidth, decrease latency, tear down PDU session, etc.) based, for example, on the current status of network connectivity, satisfaction of QoS parameters, charging, and/or changes in a user SLA.

In some embodiments, to manage QoS for a particular PDU session, the PCF 520 may match service levels with traffic patterns and consumer profiles, incorporate them into policy rules updates (even per application or slice), and supply the updates to the UE 402, UPF 516, gNB, the SMF 514, and/or the AMF 512. For example, feedback can be collected from conferencing connections (e.g., Webex, Google Meet), and some time later (days, weeks, months), if the feedback shows a change in measurements, adjustments in the slice can be made, such as routing changes (by changing route and selection rules). Ultimately, resilient load balancing can be affected. In addition, application statistics, which may include statistics received from the collection-report module 502, may be passed by the core network 504 to the CDN to make its own adjustments as needed.

The UE 402 does not have to request a modification because, through receiving the collected data “directly” from the UE, the PCF 520 can make its own policy update decisions based on the received data. Further, because different applications may have different requirements; they can be given different respective slices, with each slice meeting different requirements. Therefore, when updating policies, the PCF 520 can make and provide the needed updates per application, on a slice-by-slice basis; all policy changes do not need to be applied across the board, so routing, for example, can be adjusted for just a single slice, at any time, in real time, on the fly. These are further advantages, and improvements, over arrangements in which the PCF 520 gathers its data from external sources on the respective reporting schedules of the external sources.

At 626, the PCF 520 may send to the SMF 514 a policy update that includes a URSP to make the PDU session compliant with a QoS commitment. In some embodiments, the URSP makes the PDU session QoS compliant by defining parameters for the SMF 514 to implement by changing its rule-matching logic to change the QoS flow to one that is QoS compliant. In this regard, the PCF 520 may provide QoS rules that apply to that data session. In some examples, the SMF 514 may communicate with the PCF 520 to get the QoS rules and then send those rules to the UPF 516 and the gNB in order to apply them to the data session. The PCF 520 can access the UDR 524 to get policies that apply to a particular UE 402. An example of a rule the PCF can store or obtain from UDR is access by a UE such as access only during business hours. After business hours, the PCF sends a modified policy to the UE via the AMF.

In a similar fashion, at 628, the PCF 520 may send to the AMF 512 a policy update that includes an updated URSP to make the PDU session compliant with a target QoS; and in some embodiments request a new PDU session over a network slice to implement the updated URSP.

At 630, the AMF may send to the UE 402 the policy update that includes the URSP to make the PDU session compliant with the QoS commitment.

At 632, the UE 402 may receive the policy update from the AMF 512 that includes the updated URSP to bring the PDU session into compliance with the QoS target; and in response, adjust rule-matching logic in the UE 402 (e.g., in the cellular modem) in accordance with the updated URSP. This may include changing the logic to match uplink data traffic to the parameters for the current PDU session over the assigned network slice, and/or to select a new route (e.g., a new network slice) for data traffic. The policy update may be based on the curated data.

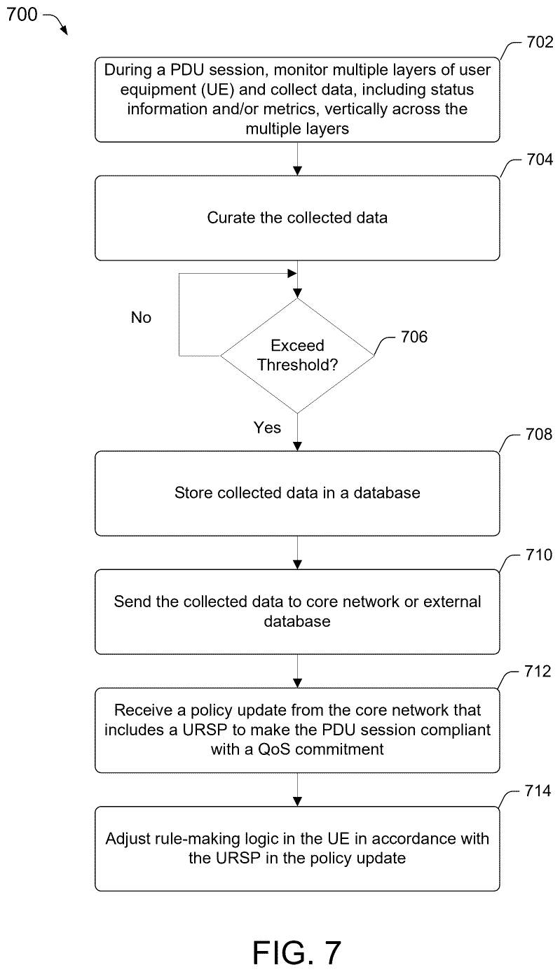

FIG. 7 illustrates an example method 700 that may be performed by a collection-report module in user equipment (UE) that includes the collection-report module and a layered architecture of multiple layers according to at least one embodiment of the disclosure. In the example of FIG. 7, the UE and the collection-report module may correspond to one or more of the UEs and collection-report modules, respectively, described herein. The UE may be configured to communicate with core network functions during a packet data unit (PDU) session over a network slice.

In block 702, during a PDU session, the collection-report module may monitor multiple layers of UE and collect data, including status information and/or metrics, vertically across the multiple layers. In some embodiments, the collection-report module may monitor packets in each of the multiple layers independently of each other layer. The multiple layers may include an application layer, a framework layer, and a physical layer. For example, the collection-report module may collect status information from the application layer and metrics from the framework layer and the physical layer. In some embodiments, status information can be collected from the physical layer and metrics may be collected from the application layer and/or framework layer. Other information can be collected as well; for example, the collection-report module may monitor packets transiting a PDCP sub-layer, an SDAP sub-layer, a radio link sub-layer, radio link control (RLC) sub-layer, and/or a radio resource control (RRC) sub-layer.

In some embodiments, the collection-report module may determine the amount of collected status information and/or metrics, and determine an amount of collected data by type of data.

The collected status information and metrics may include data that indicates anomalies. Examples of anomalies in the status information may include, without limitation, a failure in access to a network resource by one of the applications due to a failure to authenticate or authorize the application to the core network, an error, a timeout, or a delay. Anomalies in the metrics may indicate, without limitation, traffic congestion, or one or more parameters that may affect QoS in data traffic of the PDU session. In some instances, a new QoS may be dictated by a new situation, such as a new use case (e.g., initiating a gaming session during a voice call), change in the current use case (e.g., dropping video from a video conference), or change in network conditions (e.g., load balancing to alleviate traffic congestion) that requires or enables a new network slice that meets the new situation.

In block 704, the collection-report module may curate the collected data. In some embodiments, the data may be curated on the UE (e.g., by the collection-report module) to manage the amount of data to be sent to the PCF. The data gathered by the collection-report module may be interpreted, analyzed for various purposes, and/or filtered to remove data that does not meet a predetermined usage threshold. The curating can be performed in all or in part on the device, per a schedule, periodically, aperiodically, or in response to a trigger, even though each layer's data is independent of the others'and has a different syntax. For example, the metrics may be filtered to select the data most relevant to a particular policy or rule and/or by reference to a threshold to limit the amount and type of data, for example within a range predefined for the a particular metric or status, to a manageable yet sufficient amount for the purposes of the PCF. Block 704 may be performed on the data as it is being collected in block 702, on data buffered after collection, or on data that has already been stored in a database (block 706 or block 708, below). In some embodiments, curating may be omitted. For example, some data may be collected or need to be reported in small volumes, or less frequently, relative to others. In such examples, the resources devoted to curing may be better utilized differently.

In block 706, the collection-report module may determine whether some or all of the collected data exceeds a predetermined threshold. In some embodiments, the determination may include performing a learning regression on the data and comparing the output with a predetermined threshold or a predetermined trend. The predetermined threshold can be an amount of all collected data, an amount of all collected curated data, or an amount of an identified type of data (uncurated and/or curated). Alternatively, another component can be deployed for this purpose. Block 706 may be performed before curating (block 704) or after curating (i.e., on the curated data). If the data is determined not to exceed its respective threshold, the flow returns and the determination is repeated on additional data. If the data is determined to exceed its threshold, the flow may proceed to block 708. Block 706 may be performed on data that has already been stored in an on-device database (in block 708, below), and thus may be performed after block 708. In some embodiments, block 706 may be performed before block 708 on data that is not yet stored in a database, after block 708 on other data stored in the internal database, or both.

In block 708, the collection-report module may store the collected data in a database. In some embodiments, storage may occur before block 706 as noted above. In some examples, each data object in the database may have related fields that include one or more of an object name, a data identifier, amount of collected data, and a timestamp of the data collection. The data objects in the database may be stored so as to retain the existing pipeline flow syntax of each of the monitored UE layers in the database fields. In some embodiments, the data may be stored in a flattened database. The amount of collected data can be stored in the database by type such that each type can be associated with a respective threshold. The data can be stored in a database internal to the UE. Additionally, or alternatively, the data may be transmitted to an external database.

In block 710, the collection-report module may send the collected data to the core network or external database. In some embodiments, the collected data, or less than all of the collected data, may be sent in response to the amount of data of one of the types of data exceeding its respective threshold. For example, metrics collected from the lower layers may be sent when the volume of data exceeds a threshold. Similarly, errors collected from the application layer may be sent when they exceed their own predetermined threshold.

In some embodiments, the collection-report module may detect anomalies in status information collected during the PDU session, and send the detected anomalies with curated QoS data to the core network or external database upon detecting anomalies that accumulate to a predetermined threshold. In some embodiments, another module may receive the data from the collection-report module and perform anomaly detection and/or send the detected anomalies and QoS data to the core network or external database. In either case, the anomalies and QoS data can be sent concurrently, whether periodically or on a schedule, for example, as well as on reaching a threshold.

In block 712, the collection-report module may receive a policy update from the core network that includes a URSP generated by the PCF to make the PDU session compliant with a QoS commitment. In some embodiments, the URSP may make the PDU session QoS compliant by defining parameters for the UE 402 to implement by changing its rule-matching logic that governs how uplink and downlink communications are managed. To this end, the URSP may contains OSId, AppId, and IP descriptors to define the concerned application, and S-NSSAI, DNN, SSC mode information, and the like for the application and network slice mapping. Some elements of the gNB also may need to be updated, for example by receiving the policy updates from the PCF via the SMF.

In block 714, the collection-report module may adjust the rule-matching logic in the UE in accordance with the URSP in the policy update. This may include changing the logic to match uplink data traffic to the parameters for the current PDU session over the assigned network slice, and/or to select a new route (e.g., a new network slice) for data traffic. In some embodiments, the URSP may make the PDU session QoS compliant by defining parameters for the UE 402 to implement by changing its rule-matching logic to change the QoS flow to one that is QoS compliant. In some embodiments, the URSP makes the PDU session QoS compliant by defining parameters for the UE 402 to implement by changing its rule-matching logic to implement a new PDU session on a different network slice, such as by updating the slice differentiator (SD).

In some instances, the UE may achieve compliance by requesting a new PDU session over a network slice that implements the URSP. In addition, or in the alternative, in response to determining that the PDU session does not meet the QoS target, the UE may present, via a user interface on the UE, an option to leave the network slice, which the user can elect by manual input to the user interface.

In the end, from the server (core network) side, there are improvements in earlier decisionmaking due to receiving statistics earlier (i.e., from the UE 402), which enables reviewing the statistics earlier (by the UE or PCF 520, or both) and making and delivering necessary policy updates earlier because the consolidated data and messages (e.g., authentication failures, timeouts, delays, etc.) can be collected by the collection-report module 502 on the device, before other connected devices or networks can deliver the same information. Indeed, in some instances, an error can be detected on the UE 402 and delivered to the core network, whereas detected elsewhere, the error message might not be delivered at all. The UE 402 can deliver the error message with the next data flow.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. User equipment (UE), comprising
one or more processors;
a communication interface configured to transmit and receive communications between the UE and a core network of a mobile network operator (MNO) and communications over a data network via a user plane controlled from the core network;
a layered architecture that includes an application layer having applications, a framework layer having telephony services and a radio interface layer, and a physical layer having a cellular modem, the radio interface layer being an interface between the telephony services and the cellular modem, and the cellular modem being operably connected to the communication interface to transmit and receive information via the communication interface;
a collection-report module; and
memory storing the applications to access external data resources from the data network via the telephony services, the radio interface layer, and the cellular modem, the memory further storing computer-executable instructions that are executable by the one or more processors to perform operations comprising:
transmitting, via the cellular modem to the core network, a network slice request to access a network infrastructure configured to have multiple network slices over which to communicate with the data network via one or more packet data unit (PDU) sessions;
receiving, from the core network in response to the network slice request, a slice identifier of a network slice over which the UE is authorized to communicate;
executing an application in the application layer to communicate in a PDU session over the network slice;
during the PDU session, collecting data to the collection-report module vertically across the application layer, the framework layer, and the physical layer, each layer having a different respective syntax, without changing the syntax of each layer;
storing the collected status data in a flattened shareable database, each data object in the database having related fields that include an object name, a data identifier, and a timestamp of the data collection;
interpreting the stored data to ascertain a status of connectivity and anomalies in the control plane communications and user plane communications;
curating the interpreted data for quality of service (QoS) data impacting a QoS on the network slice established through UE route selection policy (URSP) rules instructed by a policy control function (PCF) of core network functions for use by the UE;
transmitting the curated data to a database;
receiving, from the core network, a policy update related to the PDU session over the network slice based on the curated data; and
adjusting, in response to receiving the policy update, rule-matching logic in the cellular modem to comply with the policy update.

2. The UE of claim 1, wherein the requested network slice is configured with network resources that support QoS parameters for a particular use case defined in a Service Level Agreement.

3. The UE of claim 1, wherein the data indicates an access failure in access to a network resource by one of the applications due to a failure to authenticate the application to the core network, a timeout, or a delay, and the policy update is a response to change the network slice to resolve the access failure.

4. The UE of claim 1, wherein the data includes QoS metrics in the PDU session that indicate a drop in QoS below a QoS target for the PDU session, and the policy update is a response to change the PDU session to a different network slice that meets the QoS target for the PDU session.

5. The UE of claim 1, wherein the anomalies and QoS data are sent concurrently.

6. The UE of claim 1, wherein listening and transmitting collected metrics and status of the multiple layers are performed during establishment of a UE policy session and during establishment of the PDU session.

7. The UE of claim 1, further comprising the database,
wherein the data object retains a layer syntax in the fields.

8. One or more computer-readable media on which are stored computer-executable instructions that, when executed by one or more processors, cause the one or more processors to perform operations that comprise:
collecting, by a collection-report module on user equipment (UE), data vertically across multiple layers in a layered architecture of the UE, the data including status information and metrics related to control plane communications and user plane communications, without changing existing pipeline data flow syntax of the multiple layers and cellular modem;
storing, by the collection-report module, the collected status data in a flattened database, each data object in the database having related fields that include an object name, a data identifier, and a timestamp of the data collection;
interpreting, by the collection-report module, the stored data to ascertain a status of connectivity and anomalies in the control plane communications and user plane communications;
curating, by the collection-report module, the interpreted data for quality of service (QoS) data impacting a QoS on the network slice established through UE route selection policy (URSP)rules instructed by a policy control function (PCF) of a core network functions for use by the UE;
determining, by the collection-report module, whether the curated QoS data indicates a QoS parameter that exceeds a predetermined threshold;
determining, by the collection-report module, from the curated QoS data that the QoS for the PDU session fails to meet a QoS target for the PDU session;
in response to determining that the PDU session fails to meet the QoS target; sending, by the collection-report module, the curated QoS data to a database;
receiving, by the collection-report module, a policy update from the core network that includes an updated URSP to bring the PDU session into compliance with the QoS target; and
adjusting, by the collection-report module, rule-matching logic in the UE in accordance with the updated URSP.

9. The one or more computer-readable media of claim 8, wherein the operations further comprise:
in response to determining that the PDU session does not meet the QoS target, presenting, by the collection-report module via a user interface on the UE, a selectable option to leave the network slice.

10. The one or more computer-readable media of claim 8, wherein the operations further comprise:
detecting, by the collection-report module, anomalies in the status information during the PDU session; and
sending, by the collection-report module, the detected anomalies with the curated QoS data to the core network upon detecting errors that accumulate to a predetermined threshold.

11. The one or more computer-readable media of claim 10, wherein the anomalies and curated QoS data are sent concurrently to the core network in response to an amount of collected data exceeding a threshold.

12. The one or more computer-readable media of claim 10, wherein the detected anomalies and curated QoS data are sent to the database according to a schedule.

13. The one or more computer-readable media claim 8, wherein the data indicates an access failure in access to a network resource by one of the applications due to a failure to authenticate the application to the core network, a timeout, or a delay, and the policy update is a response to change the network slice to resolve the access failure.

14. A method performed by a collection-report module installed in user equipment (UE), comprising:
collecting, by the collection-report module, data vertically across the multiple layers of a layered architecture of the UE, including UE status information and metrics related to control plane communications and user plane communications, without changing existing pipeline data flow syntax of the multiple layers, the UE being configured to communicate with core network functions during a packet data unit (PDU) session over a network slice;
interpreting, by the collection-report module, the collected data to ascertain status of connectivity and anomalies;
reporting, by the collection-report module, the collected data to a database;
receiving, by the collection-report module, a policy update from the core network that includes an updated UE route selection policy (URSP)to make the PDU session compliant with a target quality of service (QoS); and
requesting, by the collection-report module, a new PDU session over a network slice to implement the updated URSP.

15. The method of claim 14, wherein the multiple layers comprise an application layer that includes multiple applications and a framework layer that includes telephony services and a radio interface layer, and the method further comprises:
monitoring, by the collection-report module, packets in each of the multiple layers independently of each other layer;
detecting, by the collection-report module, from among the monitored packets collected from the application layer, application layer anomalies in one or more of timeouts, authentication failures, or delays;
detecting, by the collection-report module, via a packet data convergence protocol (PDCP) sub-layer and/or a service data adaptation protocol (SDAP) sub-layer from among the monitored packets collected from the framework layer, framework layer anomalies in data traffic of the PDU session; and
detecting, by the collection-report module, from among the monitored packets collected from the physical layer, physical layer anomalies in one or more of a radio link sub-layer, radio link control (RLC) sub-layer, and radio resource control (RRC) sub-layer.

16. The method of claim 14, wherein the URSP makes the PDU session QoS compliant by defining parameters for the UE to implement by changing rule-matching logic to change a QoS flow to one that is QoS compliant.

17. The method of claim 14, wherein the URSP makes the PDU session QoS compliant by defining parameters for the UE to implement by changing rule-matching logic to implement a new PDU session to a different network slice.

18. The method of claim 14, further comprising:
monitoring, by the collection-report module, a total amount of collected data;
determining, by the collection-report module, an amount of collected data by type of data;
storing, by the collection-report module, the amount of collected data for each type of data in a database associated by type; and
comparing, by the collection-report module, the amount of at least one of the types of data with a respective threshold,
wherein the at least one of the types of data is sent to the database in response to the amount of data of one of the types of data exceeding its respective threshold.

19. The method of claim 14, wherein the collected data includes data collected during establishment of a UE policy session and during establishment of the PDU session.

20. The method of claim 14, wherein each layer has independent data, and each layer has an individual independent syntax.
